(19) United States
(12) Patent Application Publication
(10) Pub. No.: US 2021/0241238 A1
(43) Pub. Date: Aug. 5, 2021

(54) REUSABLE FOOD OR BEVERAGE CONTAINER SYSTEM

(71) Applicant: Sperry Product Innovation, Inc., Bedford, MA (US)

(72) Inventor: Laurence B. Sperry, Newton, MA (US)

(21) Appl. No.: 17/159,066

(22) Filed: Jan. 26, 2021

Related U.S. Application Data
(60) Provisional application No. 62/970,151, filed on Feb. 4, 2020.

(51) Int. Cl. G06Q 10/00; A47G 19/22; A47L 15/42; A47L 15/24; A47L 15/00; G06K 7/10; B65G 1/04

(52) U.S. Cl. CPC G06Q 10/30; A47G 19/2227; A47L 15/4236; A47L 15/4295; A47L 15/24; A47L 15/0063; B65G 2203/0216; A47L 15/0015; G06K 7/10366; B65G 1/0485; A47L 2401/04; B65G 2201/0235; A47L 15/0076

(57) ABSTRACT

A reusable food or beverage container system and method of operation automates tracking, returning, washing, and outputting of reusable food or beverage containers. A reusable food or beverage container has an identification device associated therewith. The reusable food or beverage container is used to supply a food or beverage to a customer and associated with a customer identifier. When the customer is done using the reusable food or beverage container, it is returned to a receptacle of the system, and automatically transported to a washing subsystem where it is washed, sanitized, and dried, and then output to a stack or other organized storage structure of container.

### CROSS-REFERENCE TO RELATED APPLICATION

This application claims priority to, and the benefit of, co-pending U.S. Provisional Application No. 62/970,151, filed Feb. 4, 2020, for all subject matter common to both applications. The disclosure of said provisional application is hereby incorporated by reference in its entirety.

### FIELD OF THE INVENTION

The present invention relates to a reusable food or beverage container system that automates the process of tracking, returning, washing, and outputting of reusable food or beverage containers. In particular, the present invention relates to a reusable food or beverage container, a washing subsystem, and a tracking subsystem, which operate in combination in the reusable food or beverage container system.

### BACKGROUND

With the rapid expansion and size of the to-go food or beverage industry, for example by global businesses including national and international coffee and fast food chain restaurants, the disposal of single-use drinking containers, especially containers made with plastics, has become a serious problem. This issue is becoming more than just an environmental or public relations issue for the businesses as municipalities have begun to impose taxes on the use of single-use drinking containers. Solutions have been proposed and attempted by manufacturing cups with more environmentally-friendly materials, such as more readily recycled or composted materials. However, the required materials and manufacturing methods have not proven cost-effective as a replacement for existing, commonly used single-use drinking containers. It has also been proven to be difficult to emulate existing desired performance and features using alternate materials.

Systems to provide a means of using reusable drinking containers in place of single-use containers for to-go use have also been proposed and attempted. Such systems are typically comprised of a stock of durable reusable containers which require a deposit from the customer to use for their beverage. When the customer returns the drinking container, the deposit is returned to them. Such systems are typically easy for a customer but increase the labor and required equipment for the retailer to handle and wash the used drinking containers before they can be used again. Such increases have made it a challenge for existing retailers to overcome the cost and infrastructure change of implementing the use of such systems.

### SUMMARY

There is a need for a system for managing the use of multi-use or reusable food or beverage containers that is simple and easy to use for both the customer and the retailer. The present invention provides a system for the use of reusable food or beverage containers, such as for the to-go industry, that closely matches the existing behavior of the customer and retailer such that it can easily be deployed at existing retailers worldwide. A tracking subsystem keeps track of when a customer receives food or a beverage in one of the reusable food or beverage containers, and when that container is returned. Once returned, the container is automatically washed and sanitized such that the container is ready to be used again with little to no change in labor or behavior by the retailer employees.

In accordance with embodiments of the present invention, a reusable food or beverage container system includes a reusable food or beverage container and a tracking subsystem capable of tracking the reusable food or beverage container. The tracking subsystem includes an identification device incorporated into and associated with the reusable food or beverage container, a computing device in communication with a data store storing a status indicator of the reusable food or beverage container, and at least one reader that communicates with the identification device and exchanges container data that characterizes the identification device and associated reusable food or beverage container. The reusable food or beverage container system further includes a reusable food or beverage container receptacle, an automated washing subsystem, and an automated organizing and outputting subsystem. The reusable food or beverage container receptacle receives the reusable food or beverage container in a used and returned state and the reusable food or beverage container is conveyed to the automated washing subsystem. The automated washing subsystem washes, sanitizes, and dries the reusable food or beverage container in used and returned state transforming it to a ready state. The reusable food or beverage container in ready state is conveyed to the automated organizing and outputting subsystem. The automated organizing and outputting subsystem outputs the reusable food or beverage container in ready state and arranged for use.

In accordance with aspects of the present invention, the tracking subsystem receives the container data and updates the status indicator of the reusable food or beverage container and stores the status indicator in the data store. The status indicator can indicate a status of returned, washing, ready, and/or dispatched. An instance of the at least one reader can be disposed to read the identification device of the reusable food or beverage container prior to or at a point of handoff. The point of handoff can be at a point of sale. When the reusable food or beverage container is at the point of handoff, the reader can read the identification device and receive the container data, associate the reusable food or beverage container with a food or beverage order, and update the status indicator of the reusable food or beverage container in the tracking subsystem. The status indicator can be updated to a dispatched status.

In accordance with aspects of the invention, an instance of the at least one reader can be disposed to read the identification device of the reusable food or beverage container at a point of receipt. The point of receipt can be at the reusable food or beverage container receptacle. When the reusable food or beverage container is at the point of receipt, the reader can read the identification device and receive the container data and communicate the container data to the tracking subsystem, which can update the status indicator of the reusable food or beverage container in the tracking subsystem. The status indicator can be updated to a returned status.

In accordance with aspects of the present invention, an instance of the at least one reader can be disposed to read the identification device of the reusable food or beverage container at the automated washing subsystem. When the reusable food or beverage container is at the automated washing subsystem, the reader can read the identification device and receive the container data and communicate the container data to the tracking subsystem, which can update the status indicator of the reusable food or beverage container in the tracking subsystem. The status indicator can be updated to a washing status.

In accordance with aspects of the present invention an instance of the at least one reader can be disposed to read the identification device of the reusable food or beverage container at a storage point. The storage point can be an automated organizing and outputting subsystem. When the reusable food or beverage container is at the storage point, the reader can read the identification device and receive the container data and communicate the container data to the tracking subsystem, which can update the status indicator of the reusable food or beverage container in the tracking subsystem. The status indicator can be updated to a ready status.

In accordance with aspects of the present invention, the automated organizing and outputting subsystem can include an automated stacking subsystem that places the reusable food or beverage container onto an existing stack of containers or places the reusable food or beverage container to initiate a new stack of containers. The automated stacking subsystem can include an electromechanical device that lifts or pushes the reusable food or beverage container onto or into a stack or lowers or drops the reusable food or beverage container substantially vertically onto a stack. The automated organizing and outputting subsystem can include an automated aligning subsystem that places the reusable food or beverage container into a predetermined aligned arrangement.

In accordance with aspects of the present invention, a first conveying mechanism can be provided that receives the reusable food or beverage container in at the receptacle and feeds the reusable food or beverage container to the automated washing subsystem. The first conveying mechanism can include an electro-mechanical device capable of moving the reusable food or beverage container and optionally a lid and comprising one or more of conveyor belts, automated grippers, robotic arms, rotary conveyors, and mechanical actuators. A second conveying mechanism can be provided that receives the reusable food or beverage container from the automated washing subsystem and feeds the reusable food or beverage container to the automated organizing and outputting subsystem. The second conveying mechanism can include an electro-mechanical device capable of moving the reusable food or beverage container and optionally a lid and comprising one or more of conveyor belts, automated grippers, robotic arms, rotary conveyors, and mechanical actuators, and the like.

In accordance with aspects of the present invention, the identification device can be one or more of a bar code, a quick response (QR) code, or a near-field communication (NFC) chip. The reusable food or beverage container receptacle can be sized, dimensioned, and configured to receive the reusable food or beverage container. The reusable food or beverage container receptacle further can include a door covering an opening of the reusable food or beverage container receptacle. The automated washing subsystem can be a dishwashing system.

In accordance with embodiments of the present invention, a method of managing reusable food or beverage containers using a reusable food or beverage container system includes providing a reusable food or beverage container system comprising a reusable food or beverage container, a tracking subsystem with at least one reader, a reusable food or beverage container receptacle, an automated washing subsystem, and an automated organizing and outputting subsystem, the reusable food or beverage container having an identification device incorporated therein and readable by the at least one reader. A customer order for a food or beverage can be received, the order being associated with a customer identifier. The order can be fulfilled using the reusable food or beverage container in ready state. The system can associate the reusable food or beverage container identification device and associated reusable food or beverage container with the customer identifier in a computer executed data store. The customer order can be provided in the reusable food or beverage container to the customer. The customer can return the reusable food or beverage container by placing the reusable food or beverage container into the reusable food or beverage container receptacle. The automated washing subsystem can wash, sanitize, and dry the reusable food or beverage container. The automated organizing and outputting subsystem can output the reusable food or beverage container cleaned, sanitized, and dried in ready state.

In accordance with aspects of the present invention, associating the reusable food or beverage container identification device with the customer identifier can occur in a computer executed data store using one or more computing devices to create a data association between the reusable food or beverage container identification device and the customer identifier. The one or more computing devices can be located on premise with the system, or remotely in a cloud supported network environment.

In accordance with embodiments of the present invention, a method of managing reusable food or beverage containers using a reusable food or beverage container system includes providing a one or more reusable food or beverage containers with an identification device incorporated therein and having a status indicator in a tracking subsystem. One or more of the reusable food or beverage can be issued containers to fulfill a food or beverage order and updating the status indicator. One or more of the issued reusable food or beverage containers can be received at a receptacle and updating the status indicator. Washing, sanitizing, and drying the one or more received reusable food or beverage containers can occur in a washing subsystem. The one or more cleaned reusable food or beverage containers can be outputted using an organizing and outputting subsystem and updating a status indicator.

In accordance with aspects of the present invention, the status indicator can have a ready status in the tracking subsystem at the step of providing the one or more reusable food or beverage containers. Updating the status indicator at the step of issuing one or more reusable food or beverage containers can include updating the status indicator to a dispatched status in the tracking subsystem. Updating the status indicator at the step of receiving one or more of the issued reusable food or beverage containers can include updating the status indicator to a returned status in the tracking subsystem. Updating the status indicator at the step of outputting the one or more of cleaned reusable food or beverage containers can include updating the status indicator to a ready status in the tracking subsystem. Updating a status indicator of the one or more reusable food or beverage containers with a washing status can occur when the one or more reusable food or beverage containers is in the washing, sanitizing, and drying step.

In accordance with aspects of the present invention, the reusable food or beverage container identification device can be associated with a customer identifier thereby creating a data association between the reusable food or beverage container identification device and the customer identifier. The status indicator and the tracking subsystem can be executed in a computer executed data store using one or more computing devices. The one or more computing devices can be located on premise with the system, or remotely in a cloud supported network environment.

### BRIEF DESCRIPTION OF THE FIGURES

These and other characteristics of the present invention will be more fully understood by reference to the following detailed description in conjunction with the attached drawings, in which:

FIG. 1 is a diagrammatic illustration of a reusable food or beverage container system, according to embodiments of the present invention;

FIG. 2 is an isometric view of a housing containing an example washing subsystem of the reusable food or beverage container system that accepts reusable food or beverage containers with lids attached thereto;

FIG. 3 is an isometric view of the housing containing an example washing subsystem of the reusable food or beverage container system that accepts reusable food or beverage containers;

FIG. 4 is an isometric view of the housing containing an example washing subsystem of the reusable food or beverage container system that accepts reusable food or beverage containers and lids separated therefrom;

FIG. 5 is an isometric view of an example reusable food or beverage container for use in the reusable food or beverage container system;

FIG. 6 is an isometric view of a multi-functional scanner used to read order information on the reusable food or beverage container as well as any identifier of the reusable food or beverage container itself for use within the system;

FIG. 7 is a flow diagram illustrating operation of a reusable food or beverage container system.; and

FIG. 8 is a diagrammatic illustration of a computing device and related hardware for use in implementation of the present invention.

### DETAILED DESCRIPTION

An illustrative embodiment of the present invention relates to a reusable food or beverage container system that automates the process of tracking, returning, washing, and outputting of reusable food or beverage containers. The system provides a simple, efficient, and easy to use method for the implementation of the reusable food or beverage containers to replace the current prevalent use of wasteful and environmentally harmful single-use cups and take-out food containers that require recycling or disposal.

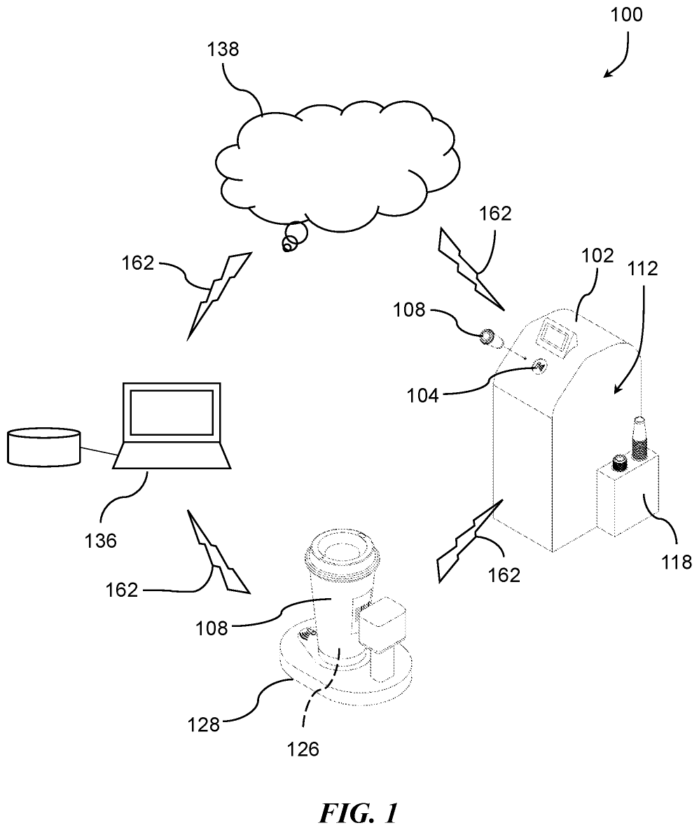

FIGS. 1 through 8, wherein like parts are designated by like reference numerals throughout, illustrate an example embodiment or embodiments of a reusable food or beverage container system, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

FIG. 1 shows a diagrammatic illustration of a reusable food or beverage container system 100 in accordance with embodiments of the present invention. The example reusable food or beverage container system 100 depicted in the figures uses a beverage container for the description and figures merely for purposes of teaching how the invention can be specifically implemented. However, those of skill in the art will readily appreciate that other food or beverage containers can be implemented in the system 100 described herein with modification to some of the components for the specific size, shape, and configuration of the containers, such that the present invention is intended to be universally applicable and operable for a variety of different food or beverage container configurations and is not limited to the specific beverage container shown and described. It should also be appreciated that for purposes of efficiency, the references herein to a reusable beverage container and corresponding system are fully applicable to all possible food or beverage containers and corresponding systems. For the avoidance of doubt, references to the reusable beverage container and corresponding system herein are transferable to other food or beverage containers, such as but not limited to, pizza boxes, Asian food takeout containers, donut boxes, pastry boxes, to-go restaurant food containers, coffee cups, iced coffee cups, hot chocolate cups, other disposable beverage containers, and the like, which are considered to all fall within the scope of the present inventive system.

Continuing with the example beverage container system, a housing 102 can contain a number of subsystems including a receptacle 104 for receiving a reusable beverage container 108 (and optionally a lid 110 shown in other figures) and an automated washing subsystem 112 disposed therein. An organizing and outputting subsystem 118 can receive the reusable beverage container from the automated washing subsystem 112 (or be integrated therewith) and organize and output cleaned reusable beverage containers 108 and/or lids 110 for use. At least one reader 128 that communicates with an identification device 126 incorporated in the reusable beverage container 108 and/or lid 110, and exchanges container data that characterizes the identification device 126 and associated reusable beverage container 108 and/or lid 110. A computing device 136 in communication with a data store 138, such as a database or other form of data storage and organization, is a portion of a tracking subsystem 160 that also includes the identification device 126, the at least one reader 128, and a communication network 162 that enables communication between the tracking subsystem components and sharing of data. The communication network 162 can be a local area network, a wide area network, wired, wireless, cloud-based, or any other network or data sharing construct understood by those of skill in the art. The computing device 136 can be on premise at the same location as, e.g., the housing 102, or remote in a network, cloud supported, wireless, or wired. Those of skill in the art will additionally appreciate that the location of each subsystem as depicted and described herein can vary such that subsystems may be combined, integrate, and/or distal, separated, in different combinations and still perform the stated functionality and operation described herein, all of which combinations are anticipated to fall within the scope of the present invention. The specific hardware and device arrangements described herein are merely representative of one example implementation of the inventive system and method and are therefore not intended to be limiting.

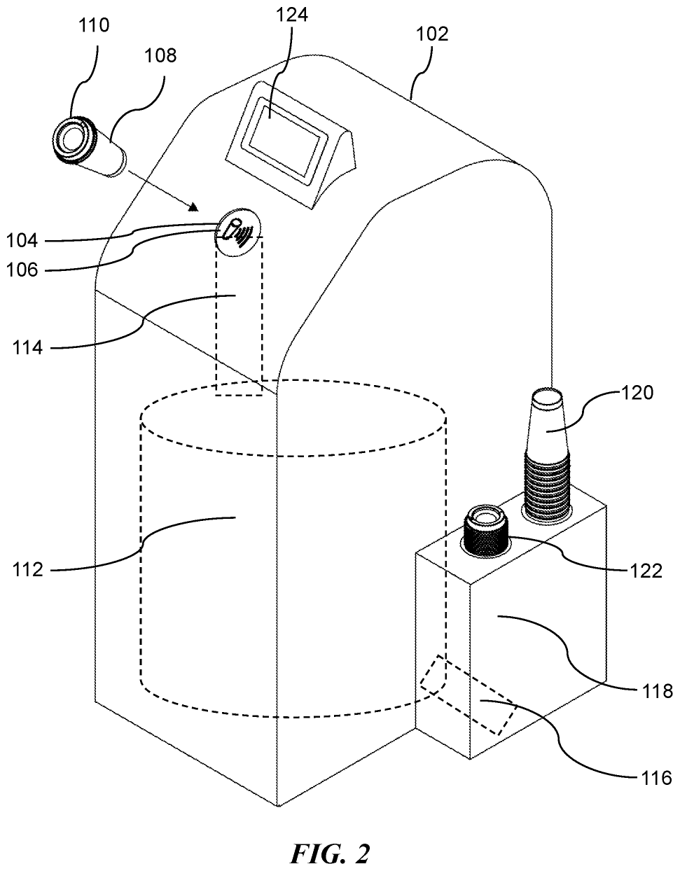

FIG. 2 shows the housing 102 that can contain a number of subsystems. As one of skill in the art would appreciate, various configurations of subsystems can be implemented keeping with the spirit and scope of the present invention, including having those subsystems contained inside the housing 102 or separated therefrom. In accordance with one example illustrative embodiment, the reusable beverage container system 100 has the reusable beverage container receptacle 104. The receptacle 104 can include a door 106 or the like of any operable configuration. The receptacle 104 is sized, dimensioned, and configured to receive a reusable beverage container 108 with a lid 110 affixed thereto. The size, dimension, and configuration of the receptacle 104 correlates to the particular reusable beverage container 108 designed for use with the system. In the example illustration, the reusable beverage container 108 and lid 110 are conventional coffee beverage cups and as such have dimensions that can vary but are generally about 2.25 inches to 2.5 inches for the small diameter, about 3 inches to 3.75 inches for the large diameter, and between about 3.25 inches to about 8 inches of height, for containers that range from, e.g., 6 oz to 22 oz of volume. Those of skill in the art will appreciate these dimensions are approximate and are intended to describe the approximate size and shape of conventional coffee cups, or the like, which conventionally fit in conventional automobile cupholders, and can be found in numerous coffee retail stores. As such, the receptacle 104 to receive any of the aforementioned cups must have a diameter slightly greater than the maximum diameter of the desired reusable beverage container largest diameter (e.g., for the above example dimensions, the receptacle 104 has a diameter of about 3.8 inches to 4 inches in order to accommodate the largest large diameter measurement). The receptacle 104 can have a door 106 that automatically slides open, or flaps shut like a one-way valve, or have another configuration readily apparent to those of skill in the art. Furthermore, those of skill in the art will appreciate the dimensional attributes are provided for enablement purposes only as it relates to a system for use with a coffee beverage reusable beverage container 108 or the like, and can be altered or varied to accommodate different containers of different dimensions for different purposes, and are therefore not limiting of the system-wide invention.

The receptacle 104 receives the reusable beverage container 108 and lid 110. Inside the housing 102 the reusable beverage container 108 and lid 110 are separated or opened and placed into the automated washing subsystem 112, such as for example by use of a first conveying mechanism 114. The first conveying mechanism 114 can have a number of different configurations, including being any form of electro-mechanical device capable of moving the reusable beverage container 108 and lid 110, such as but not limited to conveyor belts, automated grippers, robotic arms, rotary conveyors, mechanical actuators, and the like, which are readily implemented by those of skill in the art.

The automated washing subsystem 112 washes, sanitizes, and dries the reusable beverage container 108 and lid 110 such that they are ready for reuse when exiting the automated washing subsystem 112. The clean reusable beverage container 108 and lid 110 are moved from the automated washing subsystem 112 and, for example in accordance with one embodiment a second conveying mechanism 116 receives and transports the reusable beverage container 108 and lid 110 to an automated organizing and outputting subsystem 118. The second conveying mechanism 116 can be implemented in any such electro-mechanical devices as described herein relative to the first conveying mechanism 114. When the automated organizing and outputting subsystem 118 is an automated stacking subsystem, the clean reusable beverage container 108 and lid 110 are nested in a container stack 120 and lid stack 122 such that the stacks 120, 122 can be moved and dispensed in the same fashion as conventional disposable single-use containers. In accordance with example alternative embodiments, the reusable beverage container 108 and lid 110 are loaded directly into a dispensing device (not shown). In yet another embodiment, the reusable beverage container 108 and lid 110 are not nested into a stack and instead exit the system housing 102 in another organized fashion, such as via an alignment device that organizes the reusable beverage containers 108 and/or lids 110 into a dish tray or the like in a predetermined order or arrangement. The system 100 can further include a display 124 with a graphical user interface providing status and other information to the user. Depending on the desired information, the display 124 can be in communication with a processor and/or local or remote computing system via wired or wireless network connectivity, such as the computing device 136 of the tracking subsystem 160, or the like, as would be readily appreciated by those of skill in the art.

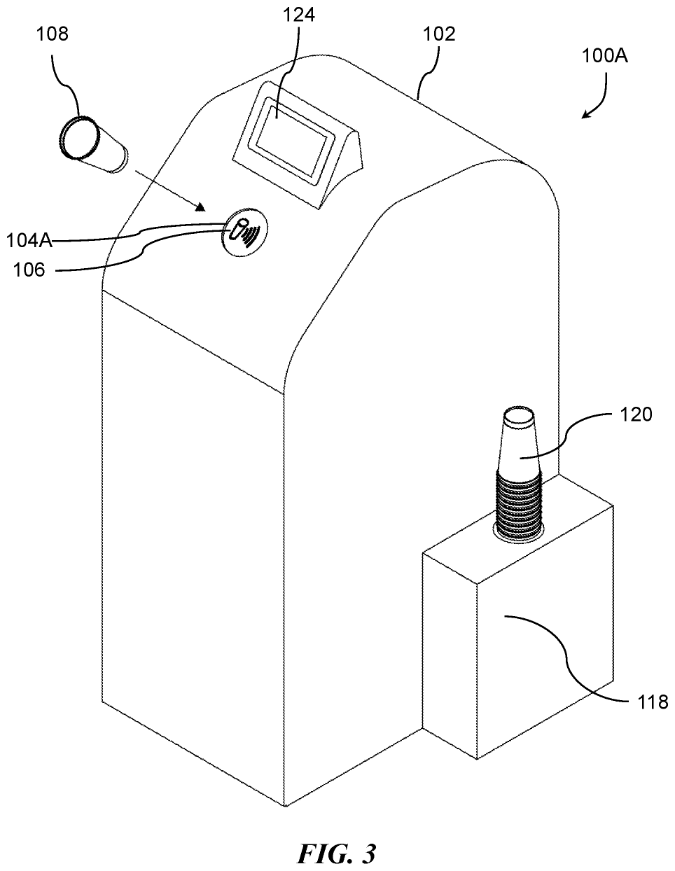

FIG. 3 illustrates an embodiment of a reusable beverage container system 100A similar to that of FIG. 2, however, in this embodiment the customer or other user can feed only the reusable beverage container 108 with any lid 110 it may have had removed and not fed into the receptacle 104A. Once the reusable beverage container 108 enters the automated washing subsystem 112 (shown in FIG. 1), the cleaning, sanitizing, and drying process proceeds as previously described, and the reusable beverage container 108 eventually exits cleaned, sanitized, and dried, into the automated organizing and outputting subsystem 118.

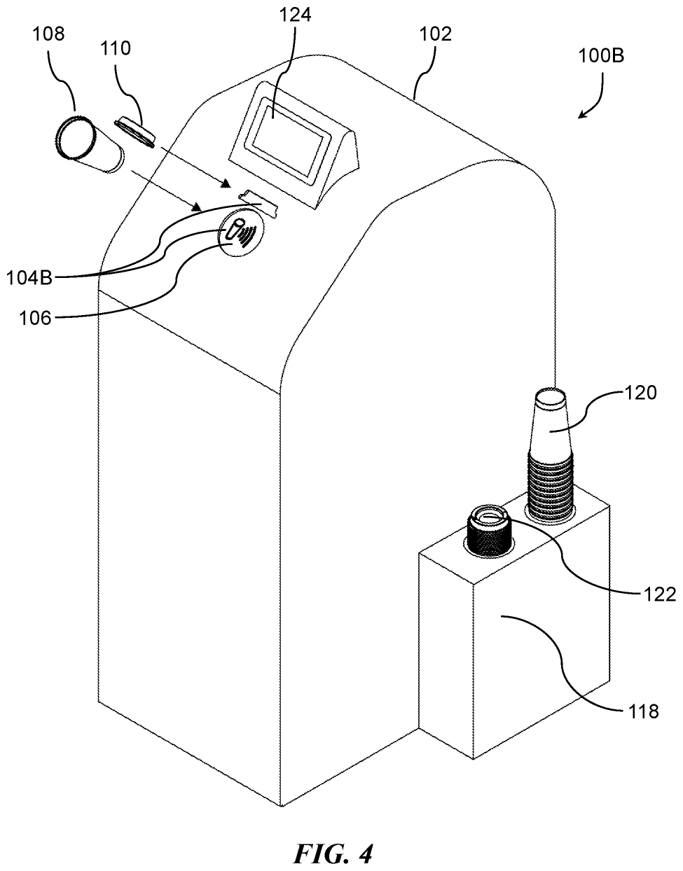

FIG. 4 illustrates an embodiment of a reusable beverage container system 100B similar to that of FIG. 2, however, in this embodiment the customer or other user can feed both the reusable beverage container 108 and the lid 110 into a receptacle 104B that has the container 108 separate from the lid 110. As such, in this instance the customer or other user opens or removes the lid 110 prior to loading into the receptacle 104B. Once the reusable beverage container 108 and the lid 110 enters the automated washing subsystem 112 (shown in FIG. 1), the cleaning, sanitizing, and drying process proceeds as previously described, and the reusable beverage container 108 and lid 110 eventually exit cleaned, sanitized, and dried, into the automated organizing and outputting subsystem 118.

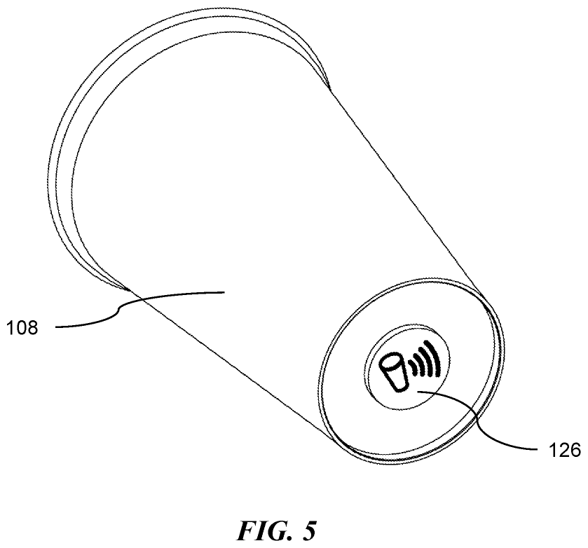

FIG. 5 shows an embodiment of the reusable beverage container 108 configured for use with the system 100 (100A, 100B). The identification device 126 is incorporated in the reusable beverage container 108 and/or lid 110, such as an RFID tag, on or embedded within the reusable beverage container 108 and/or lid 110, and is read by devices of the system, such as a reader 128 disposed at the automated washing subsystem 112 or at a receptacle 104 thereof, to track when the reusable beverage container 108 and/or lid 110 is used and subsequently returned. Various different types of identification systems and technologies, including but not limited to bar code, quick response (QR) code, near-field communication (NFC) chip, or the like, are also feasible and can be implemented as the identification device 126 and corresponding reader 128, as would be appreciated by those of skill in the art.

The reusable beverage container system 100 can also contain support devices to aid in the automation of the process of linking a customer order to a particular reusable beverage container 108 and/or lid 110.

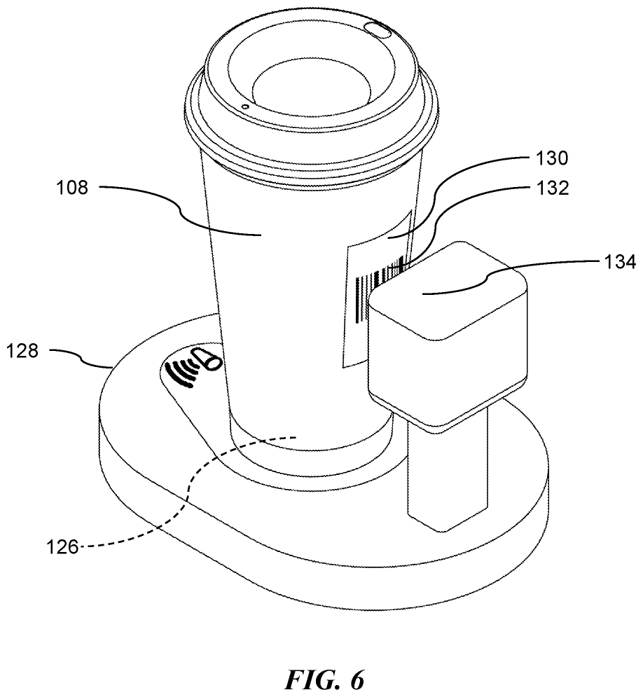

It is common practice for customer order information to be printed on an adhesive label, which is then attached to a container. This label is used by the retail employee to know which beverage is intended for that container, and by the customer to identify which container contains their order and desired beverage. FIG. 6 shows the at least one reader 128 that can contain a multifunction scanner, including optionally containing an optical reader 134, that can read an identification mark 132 on a label 130 that has been attached to a reusable beverage container 108, such as a bar code, QR code, optical character recognition, or the like, to read the identifier of the reusable beverage container 108 as described herein. As such, the customer or order and a customer identifier is linked to that specific reusable beverage container 108 in order to track, charge a refundable deposit for use, or other reasons described herein. Other embodiments, such as a printer connected to the system that can print and apply the label 130, or print directly on the reusable beverage container 108, while reading the identification device 126 of the reusable beverage container 108 are also practicable. At a point of receipt, the system 100 reads the identification device 126 of the reusable beverage container 108 as it is received by the receptacle 104 to credit the return of that reusable beverage container 108 by the customer. The system 100, leveraging the tracking subsystem 160 including a processor of a computing device 136, tracks the return of the reusable beverage container 108 and lid 110 at the point of receipt using unique identifiers of each. In other embodiments, only one of the reusable beverage container 108 or lid 110 is tracked.

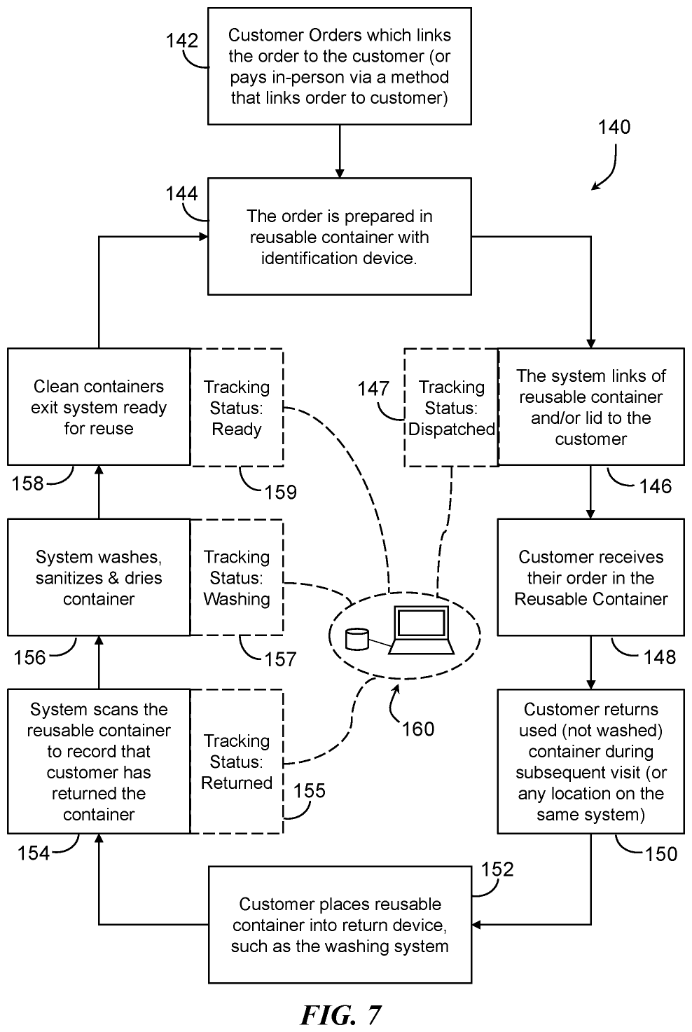

FIG. 7 is a flow diagram of a reusable beverage container system process 140 in operation that links a unique identification of a reusable beverage container 108 to a customer order such that the system 100 tracks, using the tracking subsystem 160, when that same reusable beverage container 108 is returned to the retailer, or any other retailer using the same system 100 and at a point of receipt. Specifically, the customer orders a beverage either directly at a service counter or using an application on a smartphone or a kiosk and that order is linked to the customer via customer identifier (step 142). The order is fulfilled in a reusable beverage container 108 and optionally includes a lid 110 (which can be done by a server or can be automated), each of the reusable beverage container 108 and lid 110 can include an identification device 126 (step 144). The system 100 associates the reusable beverage container 108 and/or lid 110 with the customer, via customer identifier and using a reader 128 disposed prior to or at the point of handoff, in a computer executed database, such as data store 138 (step 146). By association what is meant is creating a database or other data association between an identification of the customer, e.g., a customer identifier, and the identification device 126, and maintaining that association in a data store 138 accessible by the tracking subsystem 160. The computer executed database can be operated locally at the retail establishment, or can be operated distally via, e.g., a cloud server, and in wired or wireless communication with any system 100 installations at all retail and service locations, any of which configurations are readily understood by those of skill in the art such that additional details regarding such database systems are not required. A status indicator of the reusable beverage container 108 and/or lid 110 in the tracking subsystem 160 can optionally be set to dispatched status (step 147). The customer receives their order in the reusable beverage container 108, optionally including a lid 110, if desired (step 148). The customer later returns the used and unwashed (or washed) reusable beverage container 108 and/or lid 110 either before leaving the establishment where the beverage was procured, or after leaving and later returning to the same location or any location where the inventive system 100 is operable with a receptacle 104 (step 150), and at a point of receipt. The customer places the reusable beverage container 108 and/or lid 110 into a receptacle 104 (step 152). An instance of the reader 128 disposed at the receptacle 104 receiving the reusable beverage container 108 and/or lid 110 retrieves, e.g., reads, the identification device 126 and records the reusable beverage container 108 and/or lid 110 having been appropriately returned (step 154) and stores the container data in the data store 138 while optionally updating the status indicator to a returned status (step 155). The automated washing subsystem 112 washes, sanitizes, and dries the reusable beverage container 108 and/or lid 110 (step 156). An instance of a reader 128 disposed at the automated washing subsystem 112 can again read the identification device 126 and optionally record the reusable beverage container 108 and/or lid 110 as being in a washing status (step 157). The cleaned reusable beverage container 108 and/or lid 110 exits the automated washing subsystem 112 and using an organizing and outputting subsystem 118 is stacked or otherwise arranged and stored ready for use (step 158). An instance of a reader 128 disposed at the organizing and outputting subsystem 118 can again read the identification device 126 and optionally record the reusable beverage container 108 and/or lid 110 as being in a ready status (step 159). The process 140 can then repeat with a new order prepared in the reusable beverage container 108 and/or lid 110 (step 144), with hundreds or thousands or hundreds of thousands of repeated cycles depending on the durability and longevity of the reusable beverage container 108 and/or lid 110 materials and condition.

In some embodiments of the reusable beverage container system 100, a refundable deposit is charged for the use of the reusable beverage container 108 and/or lid 110 to encourage return or charge a penalty if the reusable beverage container 108 and/or lid 110 is not returned within a specified time. In another embodiment, the reusable beverage container system 100 uses and/or tracks the customer information without a charge. In yet another embodiment, the reusable beverage containers 108 and/or lids 110 of the system have identical tracking information such that the customer can return any container or lid to credit the return of their reusable beverage container 108 and/or lid 110.

In one embodiment, the customer loads the used reusable beverage container 108 directly into the automated washing subsystem 112, while in another embodiment, the customer returns the reusable beverage container 108 and/or lid 110 to a remote collection device form of a receptacle 104, and the reusable beverage containers 108 and/or lids 110 are then moved to and subsequently loaded into the automated washing subsystem 112.

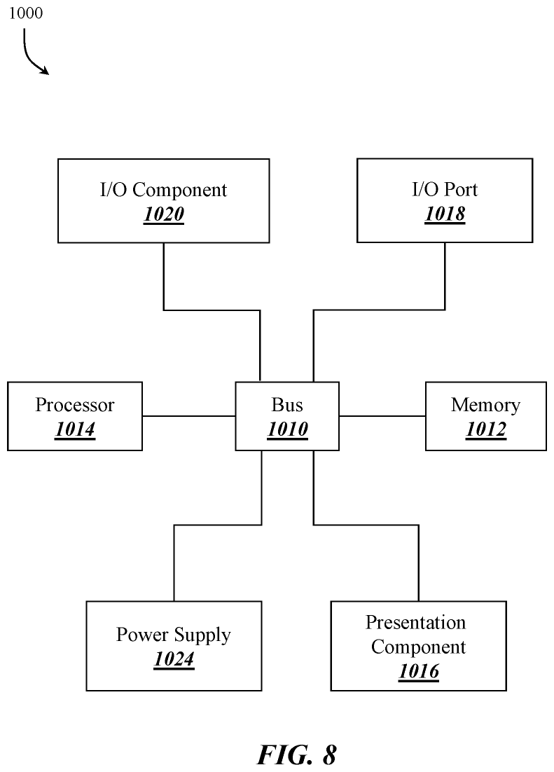

FIG. 8 depicts an example electronic, computer, or computing device 1000 that can be used to implement one or more aspects of the present invention. The functionality and hardware of such computing device 1000 may be implemented in any of the electronic hardware systems or subsystems described herein as involving or using a “computer” or “computing device” or the like, or related hardware for providing all or part of the described functionality, provided as a separate device or integrated into a system or subsystem described herein, as would be appreciated and understood by those of skill in the art. The terms “computer”, “computing device”, and the like utilized herein are intended to mean a processor at its most basic form, on up to more complex computing systems, including servers and cloud-based systems, in accordance with conventional meanings of such terms. However, for purpose of completeness, example components and related accessories that are intended to be encompassed by the use of the terms “computer”, “computing device”, “processor”, and the like will be provided below in example nonlimiting form.

The computing device 1000 is merely an illustrative example of a suitable computing environment and in no way limits the scope of the present invention. An “electronic device”, “remote device,” or “personal electronic device” as represented in figures and description herein, can include a “workstation,” a “server,” a “laptop,” a “desktop,” a “hand-held device,” a “mobile device,” a “tablet computer,” a “processor,” or other computing devices, as would be understood by those of skill in the art. Given that the computing device 1000 is depicted for illustrative purposes, embodiments of the present invention may utilize any number of computing devices 1000 in any number of different ways to implement a single embodiment of the present invention. Accordingly, embodiments of the present invention are not limited to a single computing device 1000, as would be appreciated by one with skill in the art, nor are they limited to a single type of implementation or configuration of the example computing device 1000.

The computing device 1000 can include a bus 1010 that can be coupled to one or more of the following illustrative components, directly or indirectly: a memory 1012, one or more processors 1014, one or more presentation components 1016, input/output ports 1018, input/output components 1020, and a power supply 1024. One of skill in the art will appreciate that the bus 1010 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, the figures herein are merely illustrative of an exemplary computing device 1000 that can be used to implement one or more embodiments of the present invention, and in no way limits the invention.

The computing device 1000 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 1000.

The memory 1012 can include computer-storage media in the form of volatile and/or nonvolatile memory. The memory 1012 may be removable, non-removable, or any combination thereof. Exemplary hardware devices are devices such as hard drives, solid-state memory, optical-disc drives, and the like. The computing device 1000 can include one or more processors that read data from components such as the memory 1012, the various I/O components 1020, etc. Presentation component(s) 1016 present data indications to a user or other device. Exemplary presentation components include a display device, speaker, printing component, vibrating component, etc.

The I/O ports 1018 can enable the computing or electronic device 1000 to be logically coupled to other devices, such as I/O components 1020. Some of the I/O components 1020 can be built into the computing device 1000. Examples of such I/O components 1020 include a sensor (including but not limited to: weight sensor, infrared sensor, camera, chemical sensor, microphone, or the like), keypad, touchpad, joystick, recording or storage device, game pad, satellite dish, scanner, printer, wireless device, networking device, and the like, as appropriate.

To any extent utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about” and “approximately” are intended to cover variations that may existing in the upper and lower limits of the ranges of subjective or objective values, such as variations in properties, parameters, sizes, and dimensions. In one non-limiting example, the terms “about” and “approximately” mean at, or plus 10 percent or less, or minus 10 percent or less. In one non-limiting example, the terms “about” and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A reusable food or beverage container system, comprising:
a reusable food or beverage container;
a tracking subsystem, comprising:
an identification device incorporated into and associated with the reusable food or beverage container;
a computing device in communication with a data store storing a status indicator of the reusable food or beverage container; and
at least one reader that communicates with the identification device and exchanges container data that characterizes the identification device and associated reusable food or beverage container;
a reusable food or beverage container receptacle;
an automated washing subsystem; and
an automated organizing and outputting subsystem;
wherein the reusable food or beverage container receptacle receives the reusable food or beverage container in a used and returned state and the reusable food or beverage container is conveyed to the automated washing subsystem;
wherein the automated washing subsystem washes, sanitizes, and dries the reusable food or beverage container in used and returned state transforming it to a ready state;
wherein the reusable food or beverage container in ready state is conveyed to the automated organizing and outputting subsystem; and
wherein the automated organizing and outputting subsystem outputs the reusable food or beverage container in ready state and arranged for use.

2. The reusable food or beverage container system of claim 1, wherein the tracking subsystem receives the container data and updates the status indicator of the reusable food or beverage container and stores the status indicator in the data store.

3. The reusable food or beverage container system of claim 1, wherein the status indicator comprises a status of returned, washing, ready, and/or dispatched.

4. The reusable food or beverage container system of claim 1, wherein an instance of the at least one reader is disposed to read the identification device of the reusable food or beverage container prior to or at a point of handoff.

5. The reusable food or beverage container system of claim 4, wherein the point of handoff is at a point of sale.

6. The reusable food or beverage container system of claim 4, wherein when the reusable food or beverage container is at the point of handoff, the reader reads the identification device and receives the container data, associates the reusable food or beverage container with a food or beverage order, and updates the status indicator of the reusable food or beverage container in the tracking subsystem.

7. The reusable food or beverage container system of claim 6, wherein the status indicator is updated to a dispatched status.

8. The reusable food or beverage container system of claim 1, wherein an instance of the at least one reader is disposed to read the identification device of the reusable food or beverage container at a point of receipt.

9. The reusable food or beverage container system of claim 8, wherein the point of receipt is at the reusable food or beverage container receptacle.

10. The reusable food or beverage container system of claim 8, wherein when the reusable food or beverage container is at the point of receipt, the reader reads the identification device and receives the container data and communicates the container data to the tracking subsystem, which updates the status indicator of the reusable food or beverage container in the tracking subsystem.

11. The reusable food or beverage container system of claim 10, wherein the status indicator is updated to a returned status.

12. The reusable food or beverage container system of claim 1, wherein an instance of the at least one reader is disposed to read the identification device of the reusable food or beverage container at the automated washing subsystem.

13. The reusable food or beverage container system of claim 12, wherein when the reusable food or beverage container is at the automated washing subsystem, the reader reads the identification device and receives the container data and communicates the container data to the tracking subsystem, which updates the status indicator of the reusable food or beverage container in the tracking subsystem.

14. The reusable food or beverage container system of claim 13, wherein the status indicator is updated to a washing status.

15. The reusable food or beverage container system of claim 1, wherein an instance of the at least one reader is disposed to read the identification device of the reusable food or beverage container at a storage point.

16. The reusable food or beverage container system of claim 15, wherein the storage point is an automated organizing and outputting subsystem.

17. The reusable food or beverage container system of claim 15, wherein when the reusable food or beverage container is at the storage point, the reader reads the identification device and receives the container data and communicates the container data to the tracking subsystem, which updates the status indicator of the reusable food or beverage container in the tracking subsystem.

18. The reusable food or beverage container system of claim 17, wherein the status indicator is updated to a ready status.

19. The reusable food or beverage container system of claim 1, wherein the automated organizing and outputting subsystem comprises an automated stacking subsystem that places the reusable food or beverage container onto an existing stack of containers or places the reusable food or beverage container to initiate a new stack of containers.

20. The reusable food or beverage container system of claim 19, wherein the automated stacking subsystem comprises an electromechanical device that lifts or pushes the reusable food or beverage container onto or into a stack or lowers or drops the reusable food or beverage container substantially vertically onto a stack.

21. The reusable food or beverage container system of claim 1, wherein the automated organizing and outputting subsystem comprises an automated aligning subsystem that places the reusable food or beverage container into a predetermined aligned arrangement.

22. The reusable food or beverage container system of claim 1, further comprising a first conveying mechanism that receives the reusable food or beverage container in at the receptacle and feeds the reusable food or beverage container to the automated washing subsystem.

23. The reusable food or beverage container system of claim 22, wherein the first conveying mechanism comprises an electro-mechanical device capable of moving the reusable food or beverage container and optionally a lid and comprising one or more of conveyor belts, automated grippers, robotic arms, rotary conveyors, and mechanical actuators.

24. The reusable food or beverage container system of claim 1, further comprising a second conveying mechanism that receives the reusable food or beverage container from the automated washing subsystem and feeds the reusable food or beverage container to the automated organizing and outputting subsystem.

25. The reusable food or beverage container system of claim 24, wherein the second conveying mechanism comprises an electro-mechanical device capable of moving the reusable food or beverage container and optionally a lid and comprising one or more of conveyor belts, automated grippers, robotic arms, rotary conveyors, and mechanical actuators.

26. The reusable food or beverage container system of claim 1, wherein the identification device comprises one or more of a bar code, a quick response (QR) code, or a near-field communication (NFC) chip.

27. The reusable food or beverage container system of claim 1, wherein the reusable food or beverage container receptacle is sized, dimensioned, and configured to receive the reusable food or beverage container.

28. The reusable food or beverage container system of claim 1, wherein the reusable food or beverage container receptacle further comprises a door covering an opening of the reusable food or beverage container receptacle.

29. The reusable food or beverage container system of claim 1, wherein the automated washing subsystem comprises a dishwashing system.

30. A method of managing reusable food or beverage containers using a reusable food or beverage container system, the method comprising:
providing a reusable food or beverage container system comprising a reusable food or beverage container, a tracking subsystem with at least one reader, a reusable food or beverage container receptacle, an automated washing subsystem, and an automated organizing and outputting subsystem, the reusable food or beverage container having an identification device incorporated therein and readable by the at least one reader;
receiving a customer order for a food or beverage, the order being associated with a customer identifier;
fulfilling the order using the reusable food or beverage container in ready state;
the system associating the reusable food or beverage container identification device and associated reusable food or beverage container with the customer identifier in a computer executed data store;
providing the customer order in the reusable food or beverage container to the customer;
the customer returning the reusable food or beverage container by placing the reusable food or beverage container into the reusable food or beverage container receptacle;
the automated washing subsystem washing, sanitizing, and drying the reusable food or beverage container; and
the automated organizing and outputting subsystem outputting the reusable food or beverage container cleaned, sanitized, and dried in ready state.

31. The method of claim 30, wherein associating the reusable food or beverage container identification device with the customer identifier occurs in a computer executed data store using one or more computing devices to create a data association between the reusable food or beverage container identification device and the customer identifier.

32. The method of claim 31, wherein the one or more computing devices are located on premise with the system, or remotely in a cloud supported network environment.

33. A method of managing reusable food or beverage containers using a reusable food or beverage container system, the method comprising:
providing a one or more reusable food or beverage containers with an identification device incorporated therein and having a status indicator in a tracking subsystem;
issuing one or more of the reusable food or beverage containers to fulfill a food or beverage order and updating the status indicator;
receiving one or more of the issued reusable food or beverage containers at a receptacle and updating the status indicator;
washing, sanitizing, and drying the one or more received reusable food or beverage containers in a washing subsystem, thereby resulting in one or more cleaned reusable food or beverage containers; and
outputting the one or more cleaned reusable food or beverage containers using an organizing and outputting subsystem and updating a status indicator.

34. The method of claim 33, wherein the status indicator has a ready status in the tracking subsystem at the step of providing the one or more reusable food or beverage containers.

35. The method of claim 33, wherein updating the status indicator at the step of issuing one or more reusable food or beverage containers comprises updating the status indicator to a dispatched status in the tracking subsystem.

36. The method of claim 33, wherein updating the status indicator at the step of receiving one or more of the issued reusable food or beverage containers comprises updating the status indicator to a returned status in the tracking subsystem.

37. The method of claim 33, wherein updating the status indicator at the step of outputting the one or more of cleaned reusable food or beverage containers comprises updating the status indicator to a ready status in the tracking subsystem.

38. The method of claim 33, further comprising updating a status indicator of the one or more reusable food or beverage containers with a washing status when the one or more reusable food or beverage containers is in the washing, sanitizing, and drying step.

39. The method of claim 33, further comprising associating the reusable food or beverage container identification device with a customer identifier thereby creating a data association between the reusable food or beverage container identification device and the customer identifier.

40. The method of claim 33, wherein the status indicator and the tracking subsystem are executed in a computer executed data store using one or more computing devices.

41. The method of claim 40, wherein the one or more computing devices are located on premise with the system, or remotely in a cloud supported network environment.
